(19) United States
(12) Patent Application Publication
(10) Pub. No.: US 2022/0367903 A1
(43) Pub. Date: Nov. 17, 2022

(54) Electrical Energy Store and Method for Operating an Electrical Energy Store

(71) Applicant: Mercedes-Benz Group AG, Stuttgart (DE)

(72) Inventors: Holger ROTHENBURGER, Lauffen (DE); Anselm MUELBERGER, Wernau (Neckar) (DE)

(21) Appl. No.: 17/771,225

(22) PCT Filed: Oct. 6, 2020
(86) PCT No.: PCT/EP2020/077994

§ 371 Date: Apr. 22, 2022

(30) Foreign Application Priority Data
Oct. 23, 2019 (DE) 10 2019 007 363.0

(51) Int. Cl. H01M 10/04; H01M 50/264; H01M 50/211

(52) U.S. Cl. CPC H01M 10/0468; H01M 50/264; H01M 50/211

(57) ABSTRACT

An electrical energy store includes an electrode stack which has a plurality of plies disposed one above the other in a stacking direction of electrodes and separators disposed between the electrodes. The electrode stack is disposed between a first pressure plate and a second pressure plate and a pressure is exertable on the electrode stack by the first pressure plate and the second pressure plate. At least one of the first pressure plate and the second pressure plate is movable by an actuator and the actuator is controllable by a control device. The first pressure plate and the second pressure plate are coupled to each other by the actuator and a spacing of the first pressure plate and the second pressure plate from each other is changeable by the control device controlling the actuator.

### BACKGROUND AND SUMMARY OF THE INVENTION

The invention relates to an electrical energy store having at least one electrode stack, which comprises a plurality of layers of electrodes arranged one above the other in a stacking direction and separators arranged between the electrodes. A first pressure plate and a second pressure plate are provided for exerting a pressure on the at least one electrode stack arranged between the pressure plates. An actuator serves to move at least one of the pressure plates, and a control device serves to control the at least one actuator. Furthermore, the invention relates to a method for operating such an electrical energy store.

Electrical energy stores, such as, for example, high-voltage batteries for vehicle applications, for example for hybrid vehicles, plug-in hybrid vehicles or electric vehicles, or high-voltage batteries for stationary applications, such as, for example, electricity suppliers or stores, have a plurality of individual cells wired in series and/or in parallel. Inside the high-voltage battery, the individual cells are generally combined into so-called cell blocks. The individual cells can be designed as so-called hard case cells with a metallic, solid cell housing or as so-called pouch cells, which have an encasing in the form of a compound film.

The cell blocks each contain a certain number of individual cells including devices for their mechanical fixing, for electrically contacting individual cells and, optionally, for tempering, i.e., for cooling and heating. The cell block or a plurality of cell blocks are in turn housed in a closed battery housing, which in particular additionally has devices for electrically controlling and securing the battery, for example a battery management system (BMS), contactors for switching the current on and off, fuses, ammeters and similar Furthermore, the battery preferably contains ports to the outside, namely for current supply and current leakage, a coolant supply and coolant dissipation, a port for the battery controller and similar.

The mechanical fixing of the individual cells stacked one on the other for forming a cell block is generally carried out by crimping and/or adhering. Here, the axial crimping forces are applied via pressure plates arranged on the front sides of the cell block. The pressure plates are in turn connected to each other via continuous clamping means running laterally past on the cell block. The clamping means can comprise connecting bars, tension rods, threaded rods, tensioning strips or similar.

The electrochemically active part of the individual cells is a so-called electrode stack or electrode flat wrap. The electrode stack is formed by layers of cathodes and anodes and respective arresters, wherein the respective cathode layer is separated from the respective anode layer by a layer in the form of a separator. The electrode stack is crimped to the layers with a specific pre-tensioning force for ensuring function during operation.

Above all in a battery cell formed as a solid-body cell or with a battery comprising a plurality of solid-body cells, an operating pressure of several bar is required for an optimal functionality of the border layer on which the anode and the separator or the cathode and the separator abut on each other. If an anode containing a lithium metal is used in the battery cell, then a pressure of several bar is also necessary in order to optimize the so-called plating behavior or stripping behavior of the battery cell. In plating, metallic lithium is formed instead of lithium ions being stored in the electrode as needed. Stripping results in a resolution of the lithium anode.

The electrochemically active electrode material that is inside the respective individual cell and forms the cathode on one side and the anode on the other side changes its thickness depending on the state of charge (SOC) and the state of health (SOH). A typical value for the thickness growth when charging an individual cell formed as a solid-body cell with a lithium metal anode is, for example, 15 percent when the individual cell is completely charged starting from an uncharged state (the SOC correspondingly changes from 0 percent to 100 percent). A typical value for the thickness growth of the individual cell when it ages is at about 5 percent both with a solid-body cell and with a conventional individual cell with Li-ion cell chemistry in which the electrolyte is present in liquid form. This applies to the thickness growth over the entire lifetime, i.e., a decrease of the SOH of from 100 percent to 0 percent. In light of these number values, overall a thickness change of up to about 20 percent is thus to be compensated for.

In order to achieve this, elastic spring elements such as, for example, foaming mats or coil springs can be arranged in the individual cells or between the individual cells.

For example, DE 10 2009 035 482 A1 describes a battery having a plurality of battery individual cells, which are formed flatly and are tensioned between two end plates to form a cell stack. Here, spring means can be provided as passive means for supplying the cell stack with pressure. Furthermore, DE 10 2009 035 482 A1 proposes arranging a controllable, for example electromechanical, actuator between an end plate and a further end plate of the battery resting on a battery housing. This active actuator can be controlled by means of measurements of the temperature and the pressure in the cell stack.

In the battery according to DE 10 2009 035 482 A1, the end plate can be moved in relation to the further end plate by means of the electromechanical actuator, which end plate rests on the battery housing. Correspondingly, the force against the battery housing applied when moving the actuator is supported. On the one hand, it makes it necessary for the battery housing to be designed particularly robustly. In addition, it thus makes it more difficult to remove a cell block comprising the end plates from the battery housing or to dismantle the cell block. The same applies when crimping forces against structures of the vehicle are supported when installing a battery into a vehicle. This also results in a unit that can no longer be dismantled or can only be dismantled with great effort during vehicle operation.

Furthermore, the increase of pressing force owing to the principle caused by the spring characteristic curve is disadvantageous when arranging elastic elements between the individual cells with expanding electrodes. Thus, the cells or the cell block must be designed for very high axial forces. Furthermore, there is a path region that cannot be used during operation of the battery for pre-tensioning the spring to a necessary minimum crimping.

Moreover, an elastic element in the form of a spring has a long block length. This block length is the length of the spring in the completely in the completely compressed state. In a force-path diagram in which the axial pressing force is specified depending on the stretch by which the spring is compressed, the corresponding characteristic line or curve increases perpendicularly upon achieving the block length. The region from reaching this block length can thus not be used when the battery is in operation.

The object of the present invention is to create an electrical energy store of the kind specified at the start in which an improved pressure supply of the at least one electrode stack can be achieved, and to create a correspondingly improved method for operating the electrical energy store.

The electrical energy store according to the invention has at least one electrode stack, which comprises a plurality of plies of electrodes arranged one above the other in the stacking direction and separators arranged between the electrodes. The electrical energy store comprises a first pressure plate and a second pressure plate for exerting a pressure on the at least one electrode stack arranged between the pressure plates. Furthermore, the electrical energy store has at least one actuator for moving at least one of the pressure plates and a control device for controlling the at least one actuator. The pressure plates are coupled to each other by the at least one actuator, and a spacing of the pressure plates from each other can be changed by controlling, caused by the control device, the at least one actuator.

Due to the fact that the at least one actuator couples or connects the two pressure plates to each other, the spacing of the pressure plates from each other and thus the force exerted on the at least one electrode stack can be changed without a force needing to be transferred to a housing of the electrical energy store or a vehicle structure when arranging the electrical energy store in a vehicle. Instead, a system is provided by the pressure plates coupled to each other by means of the at least one actuator, the system being able to be inherently tensioned, wherein this is caused by controlling the at least one actuator by means of the control device.

Thus, the pressure plates can be actively moved onto each other or away from each other by the control device controlling the at least one actuator. Since no pressure forces need to be supported on surrounding elements, the pressure supply of the at least one electrode stack is improved. Thus, modules or units, which are formed by the electrical energy store, can be installed particularly easily into a battery housing, for example, or into a vehicle. This is because pressure forces do not need to be supported on elements, such as the battery housing or the vehicle. Thus, maintaining or exchanging a module in the form of the electrical energy store, for example, is made simpler.

Preferably, the control device is formed to initiate a supply of the at least one electrode stack with a substantially constant force depending on a respective thickness of the at least one electrode stack by means of the at least one actuator via the pressure plates.

In order to compensate for thickness changes of the at least one electrode stack, an actively controlled constant force system is preferably used which is characterised, in particular, by a substantially horizontal force-motion characteristic curve. The latter means that the force exerted on the at least one electrode stack by the pressure plates does not depend on the position of the moveable pressure plate along the path in the useable partial region of the path or the route, in which at least one of the pressure plates can be moved in relation to the other pressure plate. The moveable pressure plate can be moved forwards or moved back along the path or the route by means of the at least one actuator in parallel to the stacking direction. Correspondingly, the pressure plates can be moved onto each other in parallel to the stacking direction or away from each other along the path or the route.

If the thickness of the at least one electrode stack changes, for example due to charging or when discharging or also as a result of ageing, then the pressure plates resting flatly on the at least one electrode stack are actively, i.e., by means of the at least one actuator, moved onto each other or away from each other corresponding to the thickness change. However, a constant axial crimping emerges in the stacking direction. The force with which the pressure plates supply the at least one electrode stack and thus also the force acting on the at least one electrode stack thus remain at least substantially constant. This is also conducive to an improved pressure supply of the electrode stack.

Moreover, in contrast to the circumstances when using conventional spring elements, which can supply an electrode stack with pressure, no distance is lost due to a pre-tensioning of a spring or the spring element, which is to be provided to achieve a required minimum amount crimping. Instead, due to the preferably horizontal force-path characteristic curve of the constant force system, a battery cell having the at least one electrode stack and/or a cell block having a plurality of battery cells can be designed particularly easily and cost-effectively and also particularly compactly in terms of the claimed constructive space.

Since the at least one electrode stack is thus constantly crimped with the optimal force, this additionally does not result in any negative influence on the performance of the battery cell or the battery cells and the lifetime of the battery cell or battery cells.

The at least one actuator can couple the pressure plates to each other by the at least one actuator running around an arrangement which comprises the pressure plates and the at least one electrode stack arranged between the pressure plates. The at least one actuator can thus surround this arrangement and thus also the pressure plates or can be wound around a component comprising the pressure plates and the at least one electrode stack.

A particularly compact construction of the electrical energy store can be achieved, however, when the actuator or at least one component of the actuator is arranged between the pressure plates.

It has been shown to be further advantageous when the at least one actuator has a movement device or is formed as a movement device which is connected to the first pressure plate on one side and to the second pressure plate on the other side. Thus, a very direct force transfer to the pressure plates can be achieved for the purpose of changing the spacing of the pressure plates from each other.

The at least one actuator can be formed as a fluid regulator with at least one chamber, which is formed to receive and emit a fluid depending on the spacing of the pressure plates from each other to be set. Such a design of the at least one actuator can be implemented particularly easily in terms of the control by the control device.

Such a fluid regulator can also be referred to as a fluid muscle, in which it depends on the amount of fluid contained in the chamber as to whether the muscle contracts or extends its length. Along with a liquid, a gas, in particular, can also be used as the fluid, for example air. Such a pneumatic muscle expands in the transverse direction when the chamber is supplied with gas. As a result, the pneumatic muscle contracts in the longitudinal direction. This then has the effect that the pressure plates are moved onto each other.

The use of air as the fluid has the advantage that air can be suctioned from the surroundings or emitted or let out into the surroundings. When a gas other than air is used for introducing and letting out from the at least one chamber of the fluid regulator, a gas tank is preferably provided. The gas that is not necessary in the chamber of the pneumatic muscle can be stored in this gas tank.

Additionally or alternatively, the at least one actuator can be formed as a mechanical drive device, by means of which the spacing of the pressure plates from each other can be changed. Such a drive device also makes it possible to exactly set the spacing of the pressure plates from each other and thus the pressure, which is exerted on the at least one electrode stack arranged between the pressure plates.

This applies, in particular, when the at least one actuator is formed as an electromechanical drive device. Correspondingly, the movement energy from the drive device is preferably provided by an electric engine. This is also conducive to a control of the at least one actuator that is easy to implement.

It is simple and less effort when the drive device has a threaded spindle and/or a toothed rod. When providing a threaded spindle, it is preferably formed to be self-locking. When the drive device has the toothed rod, then it is preferably designed so as to be able to be locked mechanically. It can thus be ensured that an active locking of the toothed rod is present in the current-free state. In such cases, the electric engine driving the threaded spindle and/or the toothed rod namely does not need to be supplied with current in order to hold the at least one pressure plate that can be moved by means of the actuator in the desired position.

The threaded spindle and/or the toothed rod can be formed to change the spacing of the pressure plates from each other by actuating a lever device. This is advantageous for a flexible arrangement, in particular in terms of constructive space, of the threaded spindle or the toothed rod.

In particular when forming the at least one actuator as a mechanical, in particular electromechanical, drive device, it is advantageous when an elastic element is arranged between the at least one electrode stack and at least one of the pressure plates. This is because a constant reconstruction of the rigid system is then prevented. A tensioning mat as such an elastic element, for example, can be arranged between the at least one electrode stack and the pressure plate.

It has been shown to be further advantageous when the control device is formed to reduce the pressure exerted on the at least one electrode stack depending on an operating state of the at least one electrode stack. In other words, the active regulation of the force applied to the at least one electrode stack makes it possible to specifically vary the force depending on the operating state of the at least one electrode stack.

For example, when transporting the electrical energy store or when inoperative, i.e., when the electrical energy store is neither charged nor discharged for a long period of time, the crimping force can be reduced to zero. Furthermore, such a reduction of the crimping force to zero can be provided in the event of any danger, for example when a vehicle equipped with the electrical energy store has an accident and/or when it results in a short circuit and/or an over-charging of the electrical energy store. However, in other cases of danger, it can also be useful to reduce the pressure exerted on the at least one electrode stack via the pressure plates.

The electrical energy store can be formed as a battery cell with a cell housing, wherein the pressure plate and the at least one electrode stack are arranged inside the cell housing. With such a design, the cell housing does not have to be designed to the crimping force exerted on by the pressure plates or to the pressure exerted by the pressure plates. Instead, a packet comprising the pressure plates and the at least one electrode stack is inherently tensioned. This makes the design of the cell housing particularly simple and low effort.

Additionally or alternatively, the electrical energy store can have a plurality of battery cells arranged between the pressure plates. Here, the respective battery cell has a respective cell housing with an electrode stack arranged in the respective cell housing. A plurality of battery cells can thus also be arranged between the pressure plates, and the electrode stack of the respective battery cells can be supplied with the crimping force or the pressure via the pressure plates. In such a case, a battery housing receiving the battery cells and the pressure plates does not need to be designed to absorb the crimping force. This makes the design of the battery housing particularly simple and low effort.

In the method according to the invention for operating an electrical energy store having at least one electrode stack, which comprises a plurality of plies of electrodes arranged one above the other in a stacking direction, and separators arranged between the electrodes, a first pressure plate and a second pressure plate exert a pressure on the at least one electrode stack arranged between the pressure plates. A control device controls an actuator, and the at least one actuator moves at least one of the pressure plates. Here, the pressure plates are coupled to each other by the at least one actuator. By the control device controlling the at least one actuator, a spacing of the pressure plates from each other is changed. Thus, the pressure exerted on the at least one electrode stack can be set, in particular regulated or readjusted. Consequently, a method is created by means of which an improved pressure supply of the at least one electrode stack can be achieved.

This applies, in particular, when the pressure exerted on the at least one electrode stack by the pressure plates is held at least substantially constant by controlling the at least one actuator.

The advantages and preferred embodiments described for the electrical energy store according to the invention also apply to the method according to the invention and vice versa.

Further advantages, features and details of the invention emerge from the below description of preferred exemplary embodiments and by means of the drawings. The features and feature combinations mentioned above in the description and the features and feature combinations mentioned below in the description of the figures and/or shown in the figures alone can be used not only in the respectively specified combination, but also in other combinations or on their own without leaving the scope of the invention.

### BRIEF DESCRIPTION OF THE DRAWINGS

FIG. 1 is a graph in which force-path characteristic curves are depicted by means of curves in a constant force system of an electrical energy store and with electrical energy stores having an elastic element;

FIG. 2, in a schematic perspective, shows a battery with a plurality of battery cells which are tensioned between two pressure plates, wherein a spacing of the pressure plates from each other can be changed by controlling pneumatic muscles which are connected to the pressure plates;

FIG. 3 is a side view of a broad side of the battery which has the pressure plates shown in FIG. 2 and the packet of battery cells arranged between the pressure plates;

FIG. 4 is a side view of a front side of the battery according to FIG. 2;

FIG. 5 shows a variant of the battery with a constant force system in which the spacing between the pressure plates can be changed by controlling threaded spindles; and

FIG. 6 shows a further variant of the battery in which the spacing of the pressure plates from each other can be changed by means of a lever system.

### DETAILED DESCRIPTION OF THE DRAWINGS

In the figures, the same or functionally identical elements are provided with the same reference numerals.

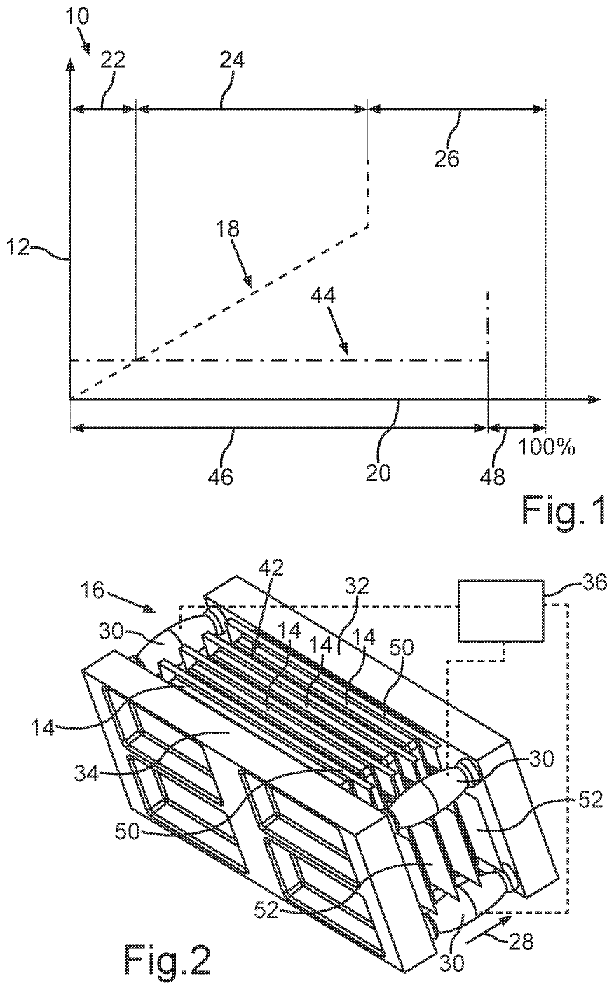

In a graph 10 shown in FIG. 1, an axial pressing force is plotted on a y-axis 12, the axial force being able to be applied in an individual battery cell 14 to an electrode stack of the battery cell 14 or in a battery 16 (c.f. FIG. 2) having a plurality of battery cells 14 to the electrode stack of the battery cells 14 stacked one on the other. Pressing together the plies of electrodes in the form of cathodes and anodes and respective plies arranged between the plies of the cathodes and the anodes of a separator of the electrode stack serves to ensure the function of the electrode stack when then battery cell 14 or the battery 16 is in operation.

A first characteristic curve 18 depicted in the graph 10 in FIG. 1 illustrates the behavior of an elastic element such as a spring, which can be arranged in a cell housing of the battery cell 14 or a battery housing (not shown) of the battery 16 (c.f. FIG. 2), in order to supply the electrode stack(s) with a pressure. In the graph 10 in FIG. 1, the path is plotted on an x-axis 20 around which the spring can be compressed. A first section 22 of the characteristic curve 18 correspondingly constitutes a region of the path around which the spring has to be pressed together to apply a required pre-tensioning force. This pre-tensioning force is set when assembling the battery cell 14 or the battery 16 or such a cell block. In this region of the path, the force that can be applied by the spring cannot be used. In contrast, a further section 24 of the characteristic curve 18 depicts a useable region of the path. In this section 24, the elastic element in the form of the spring applies and increasingly greater axial pressing force on the at least one electrode stack. The force (linearly) increases in this section 24 the further the spring is compressed.

If the spring is compressed completely, then the characteristic curve 18 increases perpendicularly. A corresponding section 26 of the path available in the battery cell 14 in the battery 16 constitutes a block length of the spring. If the spring is completely compressed, then the electrodes of the electrode stack cannot expand further perpendicularly to their stacking direction, which is illustrated in FIG. 2 by an arrow.

When using a spring or such an elastic element, the behavior of which is described by the characteristic curve 18 in the graph 10, the increase, caused in principle by the spring characteristic curve, of the pressing force is thus disadvantageous with expanding electrodes of the at least one electrode stack. Correspondingly, the battery cell 14 or the battery 16 or the cell block are set to very high axial forces.

This is presently avoided by the electrical energy store described in detail below in the form of an individual battery cell 14 or the battery 16 (c.f. FIG. 2) having a constant force system which, according to FIG. 2, comprises actuators formed, for example, as pneumatic muscles 30, a first pressure plate 32, a second pressure plate 34 and a control device 36 for controlling the actuators.

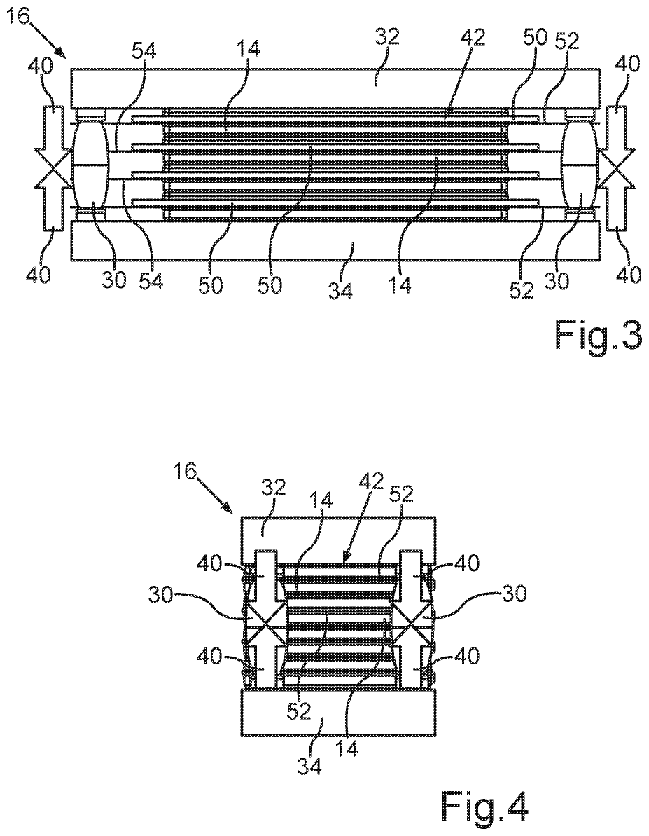

The actuators in the form of the pneumatic muscles 30, for example, can move the pressure plates 32, 34 onto each other or away from each other. The motion of the pressure plates 32, 34 onto each other is illustrated in FIG. 3 to FIG. 6 by respective arrows 50 and causes a pressure to be exerted on the respective electrode stack of the battery cells 14. In other words, the motion of the pressure plates 32, 34 onto each other causes a compression of a packet 42 of the battery cells 14 and thus the electrode stacks of the battery cells 14 in this packet 42. The packet 42 is presently arranged between the pressure plates 32, 34. Here, it is ensured by the control device 36 that a constant force is exerted in the packet 42 by means of the actuators via the pressure plates 32, 34. Thus, a constant pressures acts on the electrode stacks of the battery cells 14 of the packet 42.

A characteristic curve 44 illustrating this constant force system is also depicted in the graph 10 in FIG. 1, presently horizontal section 46 of the characteristic curve 44 constitutes the usable region of the path, along which the pressure plates 32, 34 can be moved onto each other or away from each other. It is apparent from the horizontal course of the characteristic curve 44 in the section 46 that the pressure plates 32, 34 supply the packet 42 with the constant force regardless of the path in the constant force system. This applies when supplying the battery cells 14 which have the respective electrode stack and are arranged in the packet 42 of the battery 16 (c.f. FIG. 2) with the force and, analogously, also when supplying the electrode stack arranged in a cell housing of an individual battery cell 14, when this is arranged between the pressure plates 32, 34.

The pressure plates 32, 34 cannot be moved further onto each other only in a very short end section 48 of the path, which corresponds to the movement clearance available in the battery cell 14 or the battery 16 for at least one of the pressure plates 32, 34. This can be the case, for example, because the pressure plates 32, 34 have compressed the packet 42 as much as possible or because the pneumatic muscles 30 formed as movement devices do not allow any further movement of the pressure plates 32, 34 onto each other.

Correspondingly, the characteristic curve 44 increases when the constant force system goes to the block. However, the block length or the non-useable path is clearly shorter than with the system illustrated by the characteristic curve 18 in which the spring is used. This can be seen graphically in the graph 10 from the shorter length of the end section 48 in comparison to the section 26. Furthermore, it is obvious from FIG. 1 that the region of the path which cannot be used when using the spring and which corresponds to the length of the section 22 can be used when using the constant force system.

The use of the constant force system thus ensures that at least one of the pressure plates 32, 34 resting flatly on the electrode stack or the packet 42 is actively moved forwards, i.e., for example in opposition to the stacking direction 28, or backwards, i.e., in the stacking direction 28, corresponding to the thickness change when changing the thickness of the electrode stack in the battery cells 14 or when changing the thickness of the electrode stack of an individual battery cell 14. Correspondingly, a constant axial crimping of the at least one electrode stack of the battery 16 emerges.

The change of the thickness of the electrode stack in the respective battery cell 14 or the packet 42 of the battery cells 14 in the battery 16 can be caused by charging the battery cell 14 or the battery cells 14 or discharging them. Furthermore, as a result of the battery cells 14 ageing, the thickness of the electrode stack of the battery cells 14 increases in the stacking direction 28. All these thickness changes can, however, be compensated for by the actively controlled constant force system with the preferably horizontal force-path characteristic curve, i.e., the characteristic curve 44.

The use of the constant force system is advantageous in particular when the battery cells 14 are formed as solid-body cells, which are formed as lithium ion cells in terms of the cell chemistry. Correspondingly, the positive electrode of the respective battery cell 14 can be provided by lithium compounds.

According to FIG. 2 and FIG. 3, the battery cells 14 can be formed as so-called pouch cells, in which the respective electrode stack is arranged in a flexible sleeve formed from a film material. This flexible sleeve is encompassed by a respective cell frame 50 of the battery cell 14. Furthermore, the respective battery cell 14 has arrester lugs 52, 54 (c.f. FIG. 3) by means of which electrical ports of the respective battery cell 14 are provided.

Depending on how these arrester lugs 52, 54 are interconnected to one another in the form of a respective negative pole and a respective positive pole of the battery cells 14, a required nominal voltage and/or a required current strength can be provided by the battery 16, which is preferably greater than the nominal voltage or current strength that can be provided by an individual battery cell 14. In particular, the battery 16 can be formed as a high-voltage battery or as a battery module or cell block of a high-voltage battery for a motor vehicle. Such a high-voltage battery can provide a nominal voltage of more than 60 volts, in particular of more than 100 volts. In FIG. 4, the battery 16 is shown in a view on its narrow side.

According to FIG. 2 to FIG. 4, the actuators in the form of the pneumatic muscles 30 can be arranged in respective corner regions of the pressure plates 32, 34. Thus, it can be achieved particularly simply that changes to the thickness of at least one electrode stack or packet 42 can be compensated for by actively moving the pressure plate 32, for example, forwards, i.e., in opposition to the stacking direction 28, or backwards, i.e., in the stacking direction 28. In this way, a constant axial crimping of the packet 42 emerges between the pressure plates 32, 34. As already mentioned, the thickness of the electrode stack or the packet 42 or cell stack can change due to the electrode stack or the battery cells 14 charging, discharging or ageing.

According to FIG. 2 to FIG. 4, the actuators in the form of the pneumatic muscles 30 are connected to the first pressure plate 32 on one side and to the second pressure plate 34 on the other side. Here, the pneumatic muscles 30 are arranged between the pressure plates 32, 34. If the pneumatic muscles 30 expand in the transverse direction, i.e., presently perpendicularly to the stacking direction 28, then the pneumatic muscles 30 contract in their longitudinal direction. This causes the pressure plates 32, 34 to move onto each other. It is advantageous that, in this way, an inherently tensioned system is provided. Thus, no force is transferred to a surrounding battery housing (presently not shown) of the battery 16 or to vehicle structures when arranging the battery 16 in a vehicle.

The contracting of the pneumatic muscles 30 or such fluid regulators due to a pneumatic control caused by the control device 36 leads to a movement of the pressure plates 32, 34 onto each other corresponding to the arrows 40 depicted in FIG. 3 and FIG. 4. In particular, gas, for example air, can be the fluid with which corresponding chambers formed in the manner of a tube of the pneumatic muscles 30 can be supplied. This has the advantage that air can be suctioned in from the surroundings and let out into the surroundings.

Alternatively to the pneumatic muscles presently arranged in the four corner regions of the pressure plates 32, 34, respective pneumatic muscles 30 can also be arranged on opposite sides of the packet 42, for example. These two pneumatic muscles 30 then extend along respective narrow sides of the packet 42. Furthermore, it is possible to provide actuators, which can be controlled by the control device 36 and which surround the pressure plates 32, 34 or are looped around a stack comprising the pressure plates 32, 34.

However, the packet 42, which is arranged between the two pressure plates 32, 34, can also be contracted by actuators other than the pneumatic muscles 30 presently shown by way of example. For example, electromechanical actuators can be used.

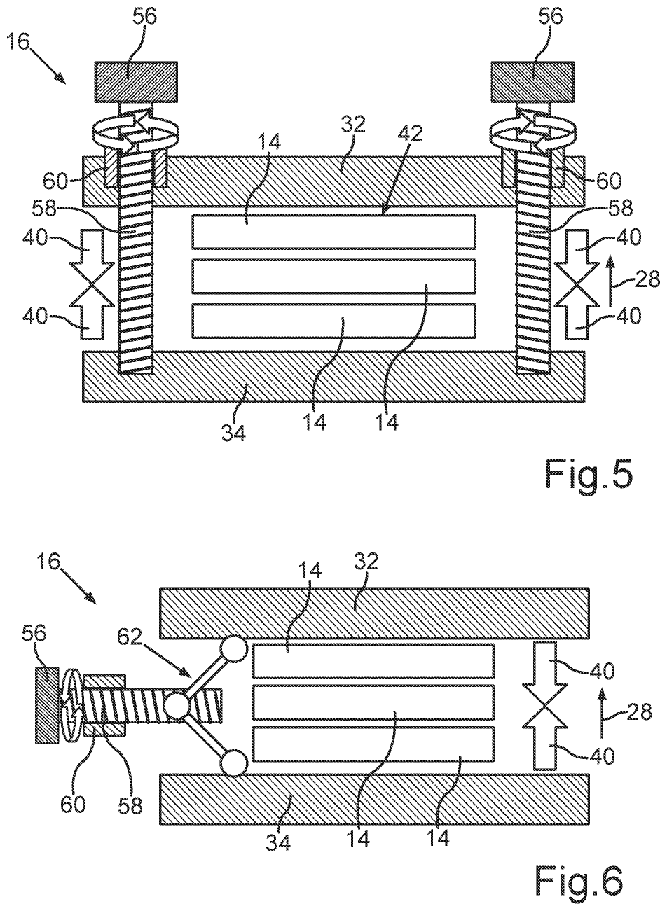

It is thus conceivable for the constant force system, in which the pressure plates 32, 34 resting flatly on the outside on the at least one electrode stack or the packet 42 or stack or the battery cells 14 are actively moved onto each other or away from each other, to be designed mechanically, in particular electromechanically. The movement energy for moving at least one of the pressure plates 32, 34 can here be provided by an electric engine 56 (c.f. FIG. 5 and FIG. 6). In FIG. 5 and FIG. 6, the control device 36 formed to control the electric engines 56 of is not shown for the sake of simplicity.

It is schematically depicted in FIG. 5 how respective movement devices arranged opposite one another perpendicularly to the stacking direction 28 in the form of threaded spindles 58 can be driven by a respective electric engine 56. Respective spindle nuts 60 can here be arranged in the region of one of the pressure plates 32, 34, as is presently shown by way of example in the region of the upper pressure plate 32 in the stacking direction 28. By rotating the threaded spindles 58 in a first direction of rotation, the pressure plates 32, 34 can be moved onto each other and, by rotating the threaded spindles 58 in the opposite direction, can be moved away from each other.

Thus, if the actuator comprising the respective electric engine 56 and the respective threaded spindle 58 in this variant is controlled by the control device 36, then the packet 42 can be supplied with a constant axial pressing force, i.e., acting in parallel to the stacking direction 28. Analogously, as shown by way of example by means of the threaded spindles 58, the spacing of the pressure plates 32, 34 from each other can also be used to compensate for the thickness changes of the battery cells 14 of the battery 16 by means of actuators, which have toothed rods that can be moved via a cogwheel.

In FIG. 6, a variant of the battery 16 is shown, in which a lever system, for example in the form of a knee lever 62, is actuated by means of a threaded spindle 58 driven by an electric engine 56. Here, the electric engine 56 and the threaded spindle 58 are arranged between the pressure plates 32, 34. In contrast, in FIG. 5 the electric engines 56 are arranged outside a receiving chamber delimited by the pressure plates 32, 34 in the stacking direction for the packet 42. Furthermore, in the variant of the battery 16 according to FIG. 6, the threaded spindle 58 extends perpendicularly to the stacking direction 28, while in FIG. 5, the threaded spindles 58 run in parallel to the stacking direction 28.

Also in the variant according to FIG. 6, instead of the threaded spindle 58, a tooth rod or similar can be used. Furthermore, analogously to the variant of the battery shown in FIG. 6, it is possible to arrange the electric engine 56 between the two pressure plates 32, 34 and to drive at least one threaded spindle 58, for example via a worm gear, which ensures that the pressure plates 32, 34 are moved onto each other or away from each other.

So that no holding energy needs to be applied, in variants in which the threaded spindle 58 is used, the threaded spindle 58 is preferably designed to be self-locking. In variants with the toothed rod (not shown), an active lock without current or brake or braking device is preferably provided.

In order to prevent a constant reconfiguration of a rigid system, such as the constant force system shown by way of example in FIG. 5 and FIG. 6, it can be useful to arrange an elastic element, such as a thin blocking mat, for example, between the packet 42 and at least one of the pressure plates 32, 34.

In addition to the variants presently described in detail, combinations of the movement mechanisms explained above are possible. For example, the lever drive shown in FIG. 6 can be activated by a fluid regulator system, such as one of the pneumatic muscles 30 shown in FIG. 2.

The constant force system can be installed once into an individual battery cell 14 or once into the battery 16. However, it is also possible to install the constant force system several times into an individual battery cell 14 or also into a cell stack such as the packet 42 presently shown by way of example. When a separate constant force system with the two pressure plates is allocated to each individual battery cell 14, for example in a cell block with several battery cells 14, then the battery cells 14 remain in their axial position despite their thickness change, i.e., in a constant position in terms of the stacking direction 28. Thus, a constant and equal grid spacing advantageously emerges.

All systems described above which comprise the two pressure plates 32, 34 which can be moved onto each other and away from each other have the advantage that they are inherently tensioned system. Correspondingly, module or units, which have the pressure plates 32, 34 and at least one battery cell 15 arranged between the pressure plates 32, 34 or the packet 42 arranged between the pressure plates 32, 34, can be installed particularly easily into a battery housing or into a vehicle. This is because pressure forces do not need to be supported on surrounding elements, such as the battery housing or the vehicle. Thus, in particular exchanging such a module is made simpler.

List of reference characters:

| | |
|---|---|
| 10 | Graph |
| 12 | y-axis |
| 14 | Battery cell |
| 16 | Battery |
| 18 | Characteristic curve |
| 20 | y-axis |
| 22 | Section |
| 24 | Section |
| 26 | Section |
| 28 | Stacking direction |
| 30 | Muscle |
| 32 | Pressure plate |
| 34 | Pressure plate |
| 36 | Control device |
| 38 | Characteristic curve |
| 40 | Arrow |
| 42 | Packet |
| 44 | Characteristic curve |
| 46 | Section |
| 48 | End section |
| 50 | Cell frame |
| 52 | Arrester lug |
| 54 | Arrester lug |
| 56 | Electric engine |
| 58 | Threaded spindle |
| 60 | Spindle nut |
| 62 | Knee lever |

1.-10. (canceled)

11. An electrical energy store, comprising:
an electrode stack which comprises a plurality of plies disposed one above the other in a stacking direction of electrodes and separators disposed between the electrodes;
a first pressure plate and a second pressure plate, wherein the electrode stack is disposed between the first pressure plate and the second pressure plate and wherein a pressure is exertable on the electrode stack by the first pressure plate and the second pressure plate;
an actuator, wherein at least one of the first pressure plate and the second pressure plate is movable by the actuator; and
a control device, wherein the actuator is controllable by the control device;
wherein the first pressure plate and the second pressure plate are coupled to each other by the actuator and wherein a spacing of the first pressure plate and the second pressure plate from each other is changeable by the control device controlling the actuator.

12. The electrical energy store according to claim 11, wherein a supply of the electrode stack with a constant force by the actuator via the first pressure plate and the second pressure plate is initiatable by the control device depending on a thickness of the electrode stack.

13. The electrical energy store according to claim 11, wherein the actuator is disposed between the first pressure plate and the second pressure plate and wherein the actuator has a movement device or is formed as movement device which is connected to the first pressure plate on a first side and to the second pressure plate on a second side.

14. The electrical energy store according to claim 11, wherein the actuator is formed as a fluid regulator having a chamber which receives and emits a fluid.

15. The electrical energy store according to claim 11, wherein the actuator is formed as a mechanical or an electromechanical drive device via which the spacing is changeable.

16. The electrical energy store according to claim 15, wherein the drive device has a threaded spindle or a toothed rod that is mechanically lockable or has a braking device and wherein the threaded spindle or the toothed rod changes the spacing by actuating a lever device.

17. The electrical energy store according to claim 11, further comprising an elastic element disposed between the electrode stack and at least one of the first pressure plate and the second pressure plate.

18. The electrical energy store according to claim 11, wherein a pressure exerted via the first pressure plate and the second pressure plate on the electrode stack is reducible by the control device depending on an operating state of the electrode stack.

19. The electrical energy store according to claim 11, wherein the electrical energy store is formed as a battery cell having a cell housing and wherein the first pressure plate, the second pressure plate, and the electrode stack are disposed inside the cell housing.

20. The electrical energy store according to claim 11, wherein the electrical energy store has a plurality of battery cells disposed between the first pressure plate and the second pressure plate and wherein a respective battery cell has a respective cell housing having the electrode stack disposed in the respective cell housing.

21. A method for operating the electrical energy store according to claim 11, comprising the step of:
changing a spacing of the first pressure plate and the second pressure plate from each other by the control device controlling the actuator.
